(19) United States
(12) Patent Application Publication
(10) Pub. No.: US 2013/0332021 A1
(43) Pub. Date: Dec. 12, 2013

(54) CONTROLLING AND MANAGING A PLURALITY OF UNMANNED GROUND VEHICLES

(71) Applicant: Amos Goren, Givatyim (IL)

(72) Inventor: Amos Goren, Givatyim (IL)

(21) Appl. No.: 13/980,622

(22) PCT Filed: Jan. 19, 2012
(86) PCT No.: PCT/IB12/50262

§ 371 Date: Aug. 20, 2013

(30) Foreign Application Priority Data
Jan. 19, 2011 (GB) 1100886.9

(51) Int. Cl. F41H 11/00; G05D 1/00

(52) U.S. Cl. CPC F41H 11/00; G05D 1/0027
USPC 701/25

(57) ABSTRACT

A system for monitoring and protecting an area. The system includes a plurality of fully autonomous and collaborating Unmanned Ground Vehicles (UGVs), each of which carries a plurality of sensors; a monitoring module; an operating module; and a GUI adapted to include threat characteristics analysis. The monitoring module actuates the plurality of UGVs to extract data from a plurality of UGV sensors; and analyzes the extracted data pertaining to the area of interest, to yield a threat analysis. The operating module is configured to: (i) determine a plurality of patrolling routes and specified strategies addressing the threat analysis; (ii) apply the determined patrolling routes to the UGVs to detect real-time threats; and (iii) operate, in response to monitored real-time threats presented over the GUI and upon a detected real-time threat, the UGVs in accordance with the specified strategies.

### CROSS-REFERENCE TO RELATED PATENT APPLICATIONS

This application claims priority from patent application GB 1100886.9, entitled “CONTROLLING AND MANAGING A PLURALITY OF UNMANNED GROUND VEHICLES”, filed on Jan. 19, 2011; and is a national stage entry of International application PCT/IB2012/050262, entitled “CONTROLLING AND MANAGING A PLURALITY OF UNMANNED GROUND VEHICLES” and filed on Jan. 19, 2012, the entire contents of which are incorporated herein by reference.

### TECHNICAL FIELD

The present invention relates to the field of security and defense of strategic sites using Dynamic and Robotics decision making System, and more particularly, to security and defense of strategic sites using autonomous Unmanned Ground Vehicles (UGV) that are managed by a dynamic robotic platform. This as full autonomous platform may replace security administrative events' preference and patrol performed by officers.

### BACKGROUND

Prior to setting forth the background of the related art, it may be helpful to set forth definitions of certain terms that will be used hereinafter.

The term “Unmanned Ground Vehicle (UGV)” as used herein in this application, is defined as a dynamic robotic platform. The dynamic robotic platform is used as replacing and as an extension of human capabilities operates on the surface of the ground. Further, the dynamic robotic platform is used to gather information about events that need to analyze if its potential threats on a strategic site, then analyze the threats' character to define the right response plan that is composed and implemented in the reactions.

A UGV is configured for perimeter protection, detection and reaction of dynamic operations, as well as rescue missions in hostile environments.

The UGV is mostly beneficial as a team of UGVs in reducing the security operators' control of enormous amount of events and in dangerous activities in which some of the activities happen in extreme weather conditions and in punishing terrain. The term “Operation Control Unit (OCU)” as used herein in this application, is defined as the Operation Control Unit system that control team of UGVs. The Operation Control Unit is configured to analyze the extracted data received from the UGVs and from plurality of sensors of the strategic site to yield an analysis of threats on the strategic site, then actuate, via a Graphical User Interface (GUI), the plurality of UGV over the strategic site in specified yield mission. These abilities used to replace the usual control center security system of critical infrastructure that receive in any moment thousand of events reported from hundreds of cameras, smart fence sensors and other fixed sensors. If you add to this security layout the element of Unmanned Ground Vehicles that report and require the intervention of an operator, it will reduce the benefit of the Unmanned Ground Vehicles that suppose to save security manpower. The OCU autonomous activities will replace the administering decision of the operator and could be monitoring by an operator.

Terrorism and other hostile activities threaten critical facilities such as airports, military bases, correctional institutions, mines, solar farms, oil and gas installations, power plants and borders. The existing art operating in such critical facilities is mostly configured to passively counter threats. The existing security and defense systems include passive elements such as fixed sensors and fixed prevention systems. Moreover, when the existing art is using UGVs it is mostly for explosive ordnance disposal in which the UGVs are controlled remotely and operated semi-autonomously only.

The military usage of UGVs like the GUARDIUM, require the control and involvement of human operator, the military UGV have certain navigation semi autonomous ability only to “locate, track and maintain line of sight to one target” without full autonomous and decision making abilities while any operation decision of the Unmanned Ground Vehicles need to be controlled and decide by an extra operator.

### SUMMARY

Embodiments of the present invention provide a method of dynamic security decision making system that is based on a method that includes the steps described hereafter. At first, gathering intelligence of the local threats on the strategic site based on the following elements: intelligence knowhow, survey of local threats and modus operandi; then, analyzing the threats, conducting a security layout plan that includes fixed sensors, deterrence and prevention systems and dynamic sensors; afterwards, analyzing the real-time threats, and then, conducting random security and dynamic routines; and finally, conducting real-time response attacks.

According to an aspect of the present invention, there is provided a system for monitoring and protecting a strategic site using a plurality of fully autonomous Unmanned Ground Vehicles (UGV) collaborating with each other and with fixed sensors.

According to another aspect of the present invention, there is provided that each UGV is carrying a plurality of sensors that transmit data to the Operation Control Unit (OCU). The Operation Control Unit is configured to analyze the extracted data received from the UGVs and the plurality of sensors vis à vis previously obtained data pertaining to the strategic site to yield an analysis of threats on the strategic site, then actuate, via a Graphical User Interface (GUI), the plurality of UGV over the strategic site in specified yield mission. All these activities can be monitoring by an operator.

According to yet another aspect of the present invention there is provided an operating module. The operating module is configured to determine via the GUI a plurality of missions, patrolling routes and specified strategies addressing the threats analysis. Further, the operating module is also configured to apply the determined missions to the UGVs to detect real-time threats. Lastly, the operating module is configured to operate the UGVs in accordance with the specified strategies for full protection of the strategic site against the detected real-time threats. The operating of the UGVs is in response to the monitored real-time threats presented over the GUI and upon a detected real-time threat.

These, other aspects of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level explanatory diagram of a system for monitoring and protecting a strategic site according to some embodiments of the invention; and

FIG. 2 is a flowchart illustrating the method of dynamic security system according to some embodiments of the invention.

### DETAILED DESCRIPTION OF EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways due to requirements of customer's site. Also, it is to be understood that the phraseology and terminology employed herein is for the purpose of description and should not be regarded as limiting.

For a better understanding of the invention, the usages of the following terms in the present disclosure are defined in a non-limiting manner:

The term “Real world experience” as used herein in this application, is defined as the experience that is required to gather and analyze data on security threats. This experience is gathered over the course of many years in the security and defense field. The experience gained over this time is used to evaluate the threats to strategic area and to prepare a local security threat survey.

The first step of the method is analyzing the threats on the strategic site and to assets if is a normal event or a threat (positive or negative alert) and then set up the threat's priorities. There are two main sources of information to the analysis of perimeter security threats. One source of information is a real world experience. Real world experience brings intelligence know-how of threats and answers the question “What are the threats?” The second source of information is a survey of local security threat. The survey of local security threat assesses the local area to determine how intelligence can be applied to counter threats on the strategic site. A combination of the two aforementioned sources provides a local threat assessment and defines a modus operandi (MO) to tackle the security threats and how they may be enacted.

The second step of the method is conducting a security layout plan. The security layout plan may include the following elements: fixed sensors, deterrence and prevention systems and dynamic sensors.

To conduct the security layout plan with lower chance to hostile interruptions, Unmanned Ground Vehicles (UGV) randomly operates in the strategic site. The random manner of the operation makes it difficult to trace the routes of the UGVs and to formulate a plan to circumvent, overcome or avoid the sensors that are located on the UGVs. Once the MO to tackle the security threats and the area of operation are defined, the UGVs are tasked to patrol the area to maximize coverage while minimizing predictability.

The third step of the method is analyzing real-time security threats. In this step, an analysis and assessment of a perimeter is conducted: to define the physical area that the threats are likely to come from, to define the physical area the threats are likely to be confronted in and to determine the location of critical assets that must be secured from threats.

Then, an evaluation of the terrain such as limitation of movement, location of fences, and predicted speed of the response of the UGV is conducted to define places in which the security response team is capable of operating. According to the evaluation, an area of operation is defined and a plan is formulated to confront the security threats in the strategic site.

The fourth step of the method is conducting a random security on dynamic routines. In this step the UGVs randomly patrol in the strategic site, thus making it difficult for the security threat to formulate a plan to circumvent the sensors located on the UGVs by tracing the UGVs routes.

The fifth step of the method is conducting a response attack in real-time. The real-time response attack is applicable due to the information shared by the UGVs. The UGVs share information with each other, with fixed sensors and with the security operator thus, allowing immediate response to security threats as they occur. The response attack of the UGVs is based on the local security threat survey and the experience of the operators that prepared the missions to handle these threats.

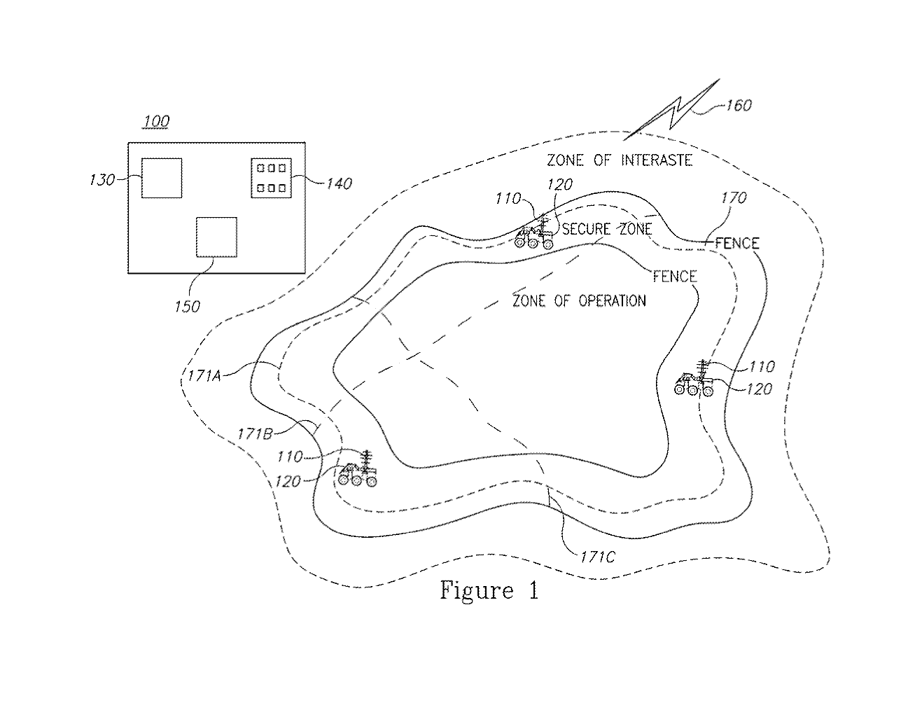

FIG. 1 is a high level explanatory diagram of a system 100 for monitoring and protecting a strategic site 170 according to some embodiments of the invention. The system 100 for monitoring and protecting the strategic site 170 may include a monitoring module 130 and a plurality of UGVs 120, each UGV 120 carrying a plurality of sensors 110. The monitoring module 130 is configured to: (i) actuate, via a GUI 140, the plurality of UGV 120 over the strategic site 170 in specified routes 171A, 171B and 171C to yield data extracted by the plurality of sensors 110 and (ii) analyze the extracted data vis à vis previously obtained data pertaining to the strategic site 170 to yield an analysis of security threats 160 of the strategic site 170. Further, the system 100 for monitoring and protecting a strategic site 170 may also include an operating module 150. The operating module 150 is configured to: (i) determine, via the GUI 140, a plurality of patrolling routes 171A, 171B and 171C and specified strategies addressing the analysis of threats, (ii) apply the determined patrolling routes 171A, 171B and 171C to the UGVs 120 to detect real-time threats 160 to the strategic site 170, and (iii) operate, in response to the monitored real-time threats 160 presented over the GUI 140 and upon the detected real-time threat 160, the UGVs 110 respond in accordance with specified strategies.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

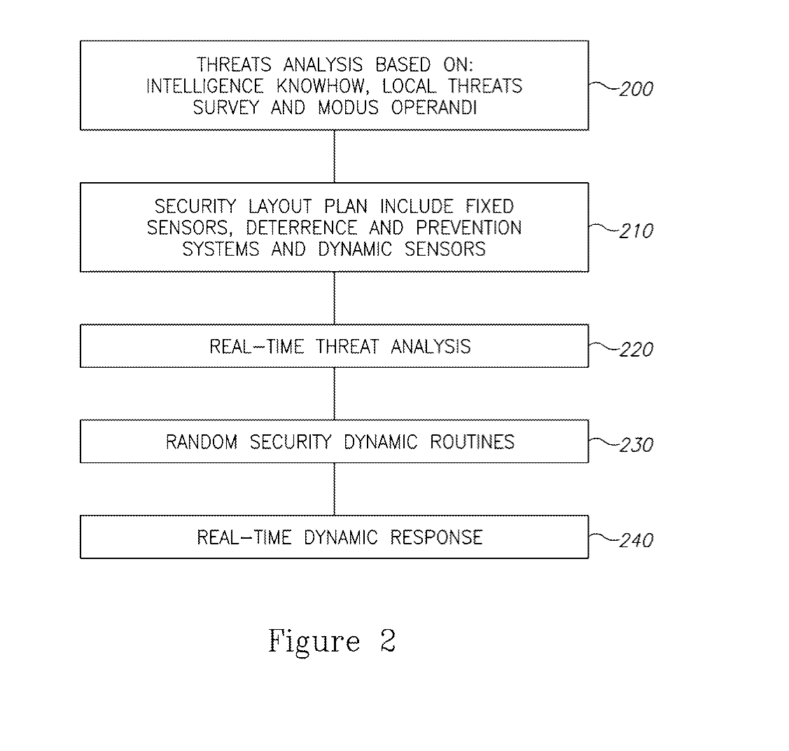

FIG. 2 is a flowchart illustrating a method of dynamic security system protecting area 170 in FIG. 1, according to some embodiments of the invention. The method includes:

Threats Analysis that is based on: intelligence knowhow, Local threats survey and modus operandi (stage 200).

Security layout plan include fixed sensors, deterrence and prevention systems and dynamic sensors (stage 210).

Real-time threat analysis (stage 220).

Random security dynamic routines (stage 230).

Real-time dynamic response (stage 240).

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for monitoring and protecting an area comprising:
a plurality of fully autonomous and collaborating Unmanned Ground Vehicles (UGVs), each of the plurality of UGVs carrying a plurality of sensors;
a monitoring module;
an operating module; and
a Graphical User Interface (GUI) adapted to include threat characteristics analysis based on: value information requirements, probability and possible damage of the threats, suspicious signs, operation scenarios and security efforts enforcement,
wherein the monitoring module is configured to: (i) actuate, via the GUI, the plurality of UGVs over a specified area of interest in specified routes, to yield data extracted by a plurality of sensors carried by the UGVs; and (ii) analyze the extracted data vis à vis previously obtained data pertaining to the specified area of interest, to yield a threat analysis of the specified area of interest, and
wherein the operating module is configured to: (i) determine, via the GUI, a plurality of patrolling routes and specified strategies addressing the threat analysis; (ii) apply the determined patrolling routes to the UGVs to detect real-time threats on the specified area of interest; and (iii) operate, in response to monitored real-time threats presented over the GUI and upon a detected real-time threat, the UGVs in accordance with the specified strategies, to achieve a protection of the specified area of interest, against the detected real-time threats.

2. The system according to claim 1, wherein the plurality of sensors is fixed.

3. The system according to claim 1, wherein the plurality of sensors is dynamic.

4. The system according to claim 1, wherein the threat analysis is based on a real world experience that entails intelligence know-how of threats.

5. The system according to claim 1, wherein the threat analysis is based on a survey of local security threat.

6. The system according to claim 1, wherein the threat analysis defines: (i) a modus operandi to tackle any security threats; and (ii) how the security threats should be enacted.

7. The system according to claim 1, wherein the plurality of UGVs patrol randomly in the specified area of interest, to reduce chance of hostile interruptions.

8. A control manager apparatus for monitoring and operating a plurality of Unmanned Ground Vehicles (UGV) comprising:
a monitoring module;
an operating module; and
a Graphical User Interface (GUI), that includes threat characteristics analysis based on value information requirements, probability and possible damage of the threats, suspicious signs, operation scenarios and security efforts enforcement,
wherein the monitoring module is configured to: (i) actuate, via the GUI, the plurality of UGVs over a specified area of interest in specified routes to yield data extracted by a plurality of sensors carried by the UGVs; and (ii) analyze the extracted data vis à vis previously obtained data pertaining to the specified area of interest to yield a threat analysis of the specified area of interest, and
wherein the operating module is configured to: (i) determine, via the GUI, a plurality of patrolling routes and specified strategies, addressing the threat analysis; (ii) apply the determined patrolling routes to the UGVs to detect real-time threats on the specified area of interest; and (iii) operate, in response to the monitored real-time threats presented over the GUI and upon a detected real-time threat, the UGVs in accordance with the specified strategies, to achieve a protection of the specified area of interest, against the detected real-time threats.

9. The control manager apparatus according to claim 8, wherein the plurality of sensors is fixed.

10. The control manager apparatus according to claim 8, wherein the plurality of sensors is dynamic.

11. The control manager apparatus according to claim 8, wherein the threat analysis is based on a real world experience that entails intelligence know-how of threats.

12. The control manager apparatus according to claim 8, wherein the threat analysis is based on a survey of local security threat.

13. The control manager apparatus according to claim 8, wherein the threat analysis defines: (i) a modus operandi to tackle security threats; and (ii) how the security threats should be enacted.

14. The control manager apparatus according to claim 8, wherein the UGV patrol randomly in the specified area of interest, to reduce chances of hostile interruptions.
